(19) United States
(12) Patent Application Publication
(10) Pub. No.: US 2018/0349269 A1
(43) Pub. Date: Dec. 6, 2018

(54) EVENT TRIGGERED DATA RETENTION

(71) Applicant: MICROSOFT TECHNOLOGY LICENSING, LLC, Redmond, WA (US)

(72) Inventors: Nakul GARG, Sammamish, WA (US); Yong Hua YANG, Sammamish, WA (US); Tho V. NGUYEN, Kenmore, WA (US); Dheepak RAMASWAMY, Bellevue, WA (US)

(73) Assignee: MICROSOFT TECHNOLOGY LICENSING, LLC, Redmond, WA (US)

(21) Appl. No.: 15/614,870

(22) Filed: Jun. 6, 2017

(51) Int. Cl. G06F 12/02; G06F 3/06

(52) U.S. Cl. CPC G06F 12/0253; G06F 3/0679; G06F 3/0602; G06F 3/0653

(57) ABSTRACT

A lifecycle of an item is controlled based on a type of the item. Particular item types may be required by law, industry, or organizational policies and procedures to be retained for a defined time period. Often these required retention policies are triggered by events, and thus embodiments are directed to providing event triggered data retention. Items stored in a hosted service environment may each be associated with a label that defines an item category, a retention type, a retention period, and/or a retention trigger for the item. In response to detecting an occurrence of a retention trigger event associated with a person or a project, the items may be queried to determine each item associated with an asset identifier identifying the person or the project. The retention period and type for each item may be updated or set based on a retention policy associated with each item.

### BACKGROUND

In the field of data management, a lifecycle of an item, such as a document or a communication, is controlled based on a type of the item. Particular types of items may be required by law, industry regulation, or organizational policies and procedures to be retained for a defined period of time. For example, employee records may be required to be preserved for 10 years from the time the employee leaves the company. After 10 years have elapsed from the employee's resignation or termination from the company, all the documents related to that particular employee will need to be disposed.

Currently implemented methods and systems are focused on property based data retention, where retention policies are applied to items based on properties of the items, such as a date the item was created or modified, or an author of the item. However, many required data retention policies are not triggered by item properties, but instead by events, such as the employee leaving the company.

### SUMMARY

This summary is provided to introduce a selection of concepts in a simplified form that are further described below in the Detailed Description. This summary is not intended to exclusively identify key features or essential features of the claimed subject matter, nor is it intended, as an aid in determining the scope of the claimed subject matter.

Embodiments are directed to providing event triggered data retention. An item stored in a hosted service environment may be associated with a label that defines an item category, a retention type, a retention period, and/or a retention trigger. A security and compliance system associated with the hosted service may be configured to detect an occurrence of a retention trigger event associated with a person or a project. In response, the security and compliance system may be configured to query items stored within the hosted service environment to determine the item associated with an asset identifier that identifies the person or the project. The security and compliance system may then be configured to update or set the retention period and the retention type for the item based on a retention policy associated with the item, where the retention policy identifies the retention period and the retention type based on the asset identifier, the item category, and the retention trigger event.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A through 1C include display diagrams illustrating an example network environment where a system to provide event triggered data retention may be implemented;

FIG. 2 includes a display diagram illustrating an example architecture of a system configured to provide event triggered data retention;

FIG. 3 includes a display diagram illustrating conceptually an example set of actions and components for providing event triggered data retention;

FIGS. 4A through 4E include display diagrams illustrating an example user interface through which a label may be selected for application to an item stored within the hosted service environment;

FIGS. 5A through 5E include display diagrams illustrating an example dashboard of a security and compliance system through which event triggered data retention policies may be created and applied;

FIG. 6 is a networked environment, where a system according to embodiments may be implemented;

FIG. 7 is a block diagram of an example computing device, which may be used to provide event triggered data retention; and

FIG. 8 illustrates a logic flow diagram of a method to provide event triggered data retention, arranged in accordance with at least some embodiments described herein.

### DETAILED DESCRIPTION

As briefly described above, embodiments are directed to providing event triggered data retention for a tenant of a hosted service. An item stored in the hosted service environment may be associated with a label, where the label defines an item category, a retention type, a retention period, and a retention trigger. A security and compliance system associated with the hosted service may be configured to detect an occurrence of a retention trigger event associated with a person or a project. For example, a termination of a person from his or her employment or a completion of a project. The occurrence may be detected through a communication, a record update, and/or manual input from a tenant administrator or user with a similar role, permissions, or credentials. In response, the security and compliance system may be configured to query items stored within the hosted service environment to determine the item associated with an asset identifier, where the asset identifier identifies the person or the project. For example, the asset identifier may be an employee number or a project number. The security and compliance system may then be configured to update or set the retention period and the retention type for the item based on a retention policy associated with the item. The retention policy may identify the retention period and the retention type based on the asset identifier, the item category, and the retention trigger event.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing event triggered data retention. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

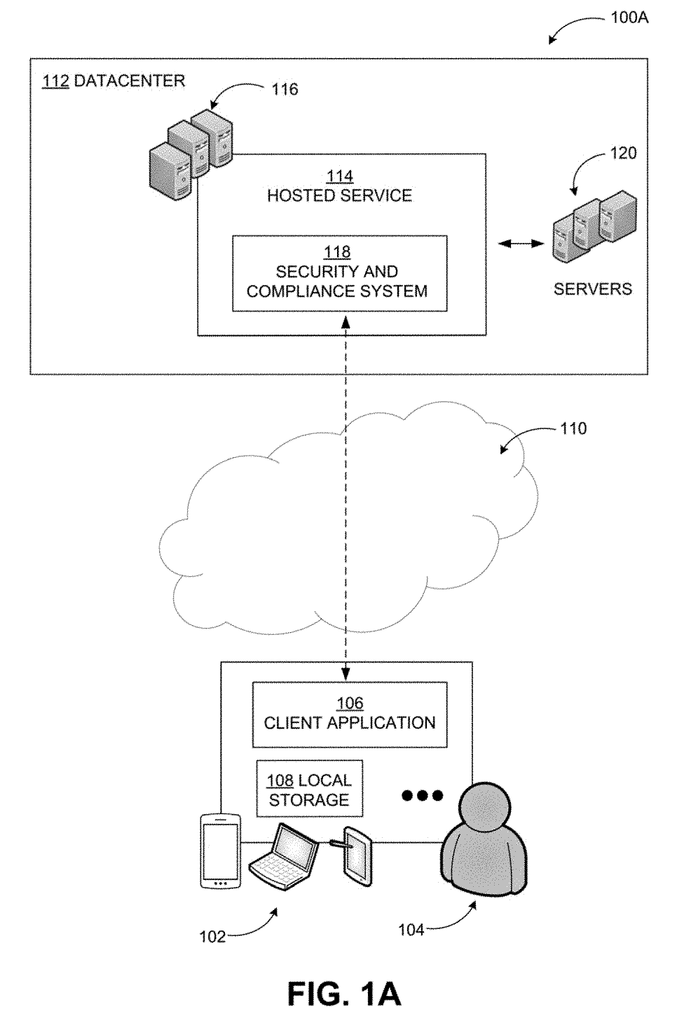

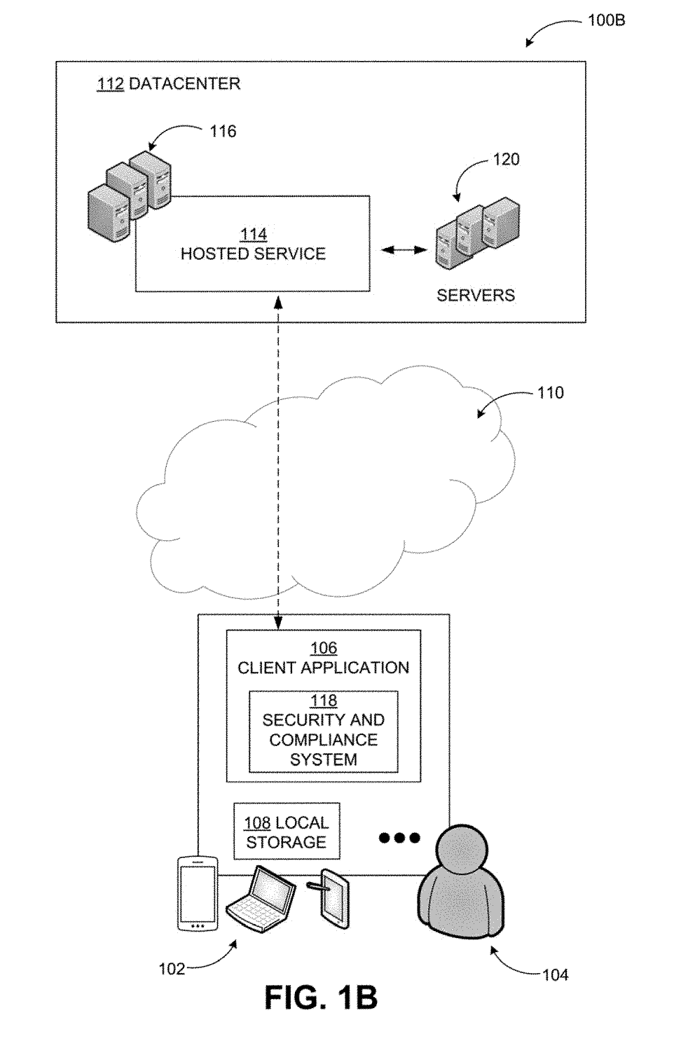

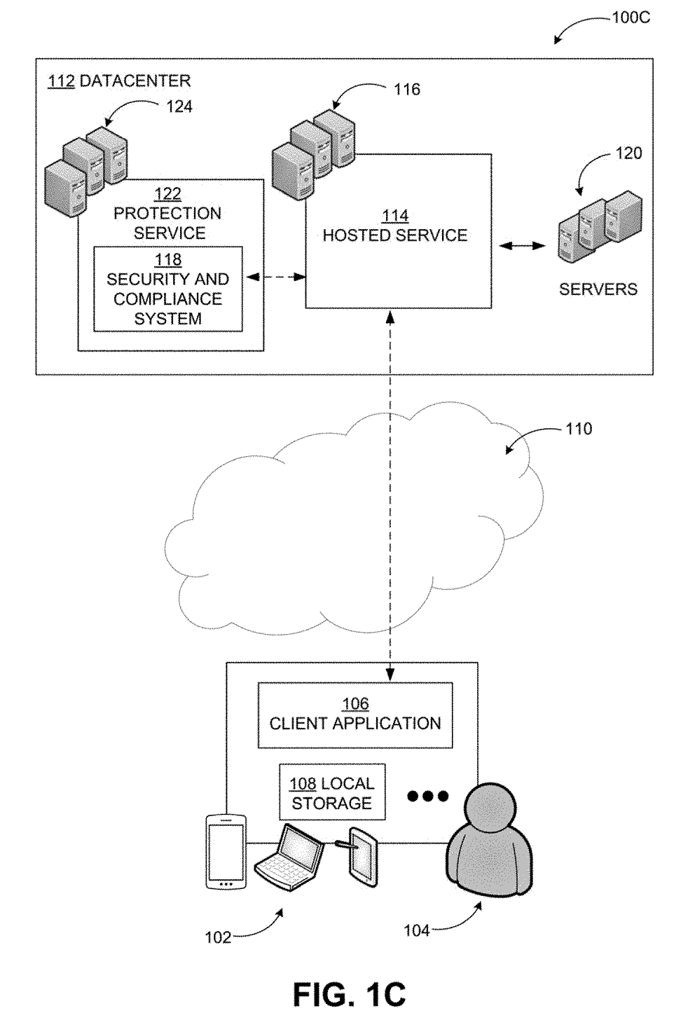

FIG. 1A through 1C include display diagrams illustrating an example network environment where a system to provide event triggered data retention may be implemented.

As illustrated in diagrams 100A-100C, an example system may include a datacenter 112 executing a hosted service 114 on at least one processing server 116, which may provide productivity, communication, cloud storage, collaboration, and comparable services to users in conjunction with other servers 120, for example. The hosted service 114 may further include scheduling services, online conferencing services, and comparable ones. The hosted service 114 may be configured to interoperate with a client application 106 through one or more client devices 102 over one or more networks, such as network 110. The client devices 102 may include a desktop computer, a laptop computer, a tablet computer, a vehicle-mount computer, a smart phone, or a wearable computing device, among other similar devices. In some examples, the hosted service 114 may allow users to access its services through the client application 106 executed on the client devices 102. In other examples, the hosted service 114 may be provided to a tenant (e.g., a business, an organization, or similar entities), which may configure and manage the services for their users.

In one embodiment, as illustrated in diagram 100A, the processing server 116 may be operable to execute a security and compliance system 118 of the hosted service 114, where the security and compliance system 118 truly be integrated with the hosted service 114. In another embodiment, as illustrated in diagram 100B, the client application 106 may be operable to execute the security and compliance system 118, where the security and compliance system 118 may be integrated with the client application 106. In a further embodiment, as illustrated in diagram 100C, the security and compliance system 118 may be integrated with a separate protection service 122 and executed by one or more processing servers 124 of the protection service 122. The protection service 122 may be configured to serve the hosted service 114 and/or multiple applications associated with the hosted service 114, such as the client application 106. Furthermore, the protection service 122 may provide its services to multiple hosted services. Thus, if a tenant subscribes to multiple hosted services, common information (e.g., tenant data/metadata and retention policies) may be used to coordinate event, triggered data retention for each of the hosted services, among other security and compliance policies, which reduces the burden on the administrators to have to implement event triggered data retention for each hosted service. As described herein, the hosted service 114, the security and compliance system 118, and the protection service 122 may be implemented as software, hardware, or combinations thereof.

In an example embodiment, a tenant administrator 104 or another user with a similar role, permissions, or credentials may create a plurality of labels for application to items stored within the hosted service environment. The tenant administrator 104 may create the labels through a user interface of the client application 106 that is being executed on one or more of the client devices 102, for example. The tenant administrator 104 may be prompted to create or update a label upon creation, modification, or deletion of all item. In some embodiments, some elements defined by the label, described in detail below, may be automatically defined by organizational defaults of the tenant.

Each label may define an item category, a retention type, a retention period, and a retention trigger. The item category may describe a general type of information or data contained within the item associated with the label, such as employee records, payroll records, marketing materials, budgets, etc. The retention type may indicate a manner in which the item is to be retained. For example, the retention type may be keep, keep and delete, delete, move to a secure storage, lock against editing, mark as inactive or locked, and/or make inaccessible to a group of users, among other examples. The retention period may be a time period required by law, industry regulation, or the tenant's organizational policies and procedures to retain the item (often based on the item category). The retention trigger may be a creation date, a last modified date, a label date, or an event date. For example, if the creation date, the last modified date, or the label date is the retention trigger, the retention period set for that item will begin on the date the item was created, the date the item was last modified, or the date the label was applied to the item, respectively. If the event date is the retention trigger, the retention period set for that item will begin on the date that a retention trigger event occurs.

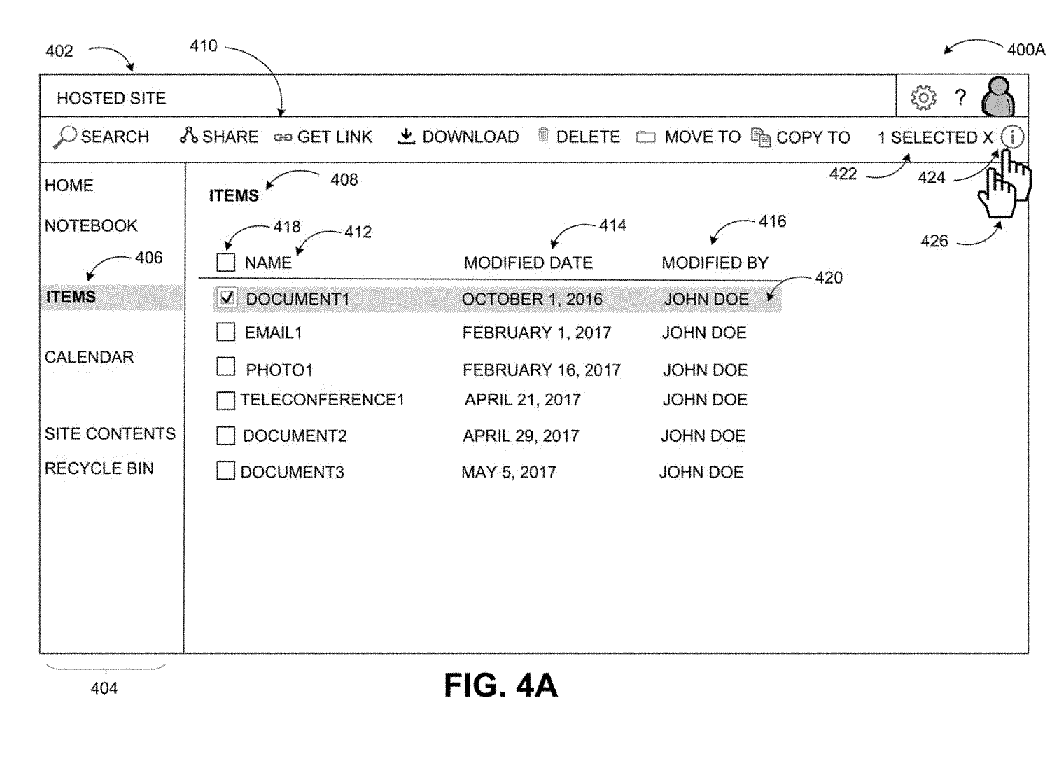

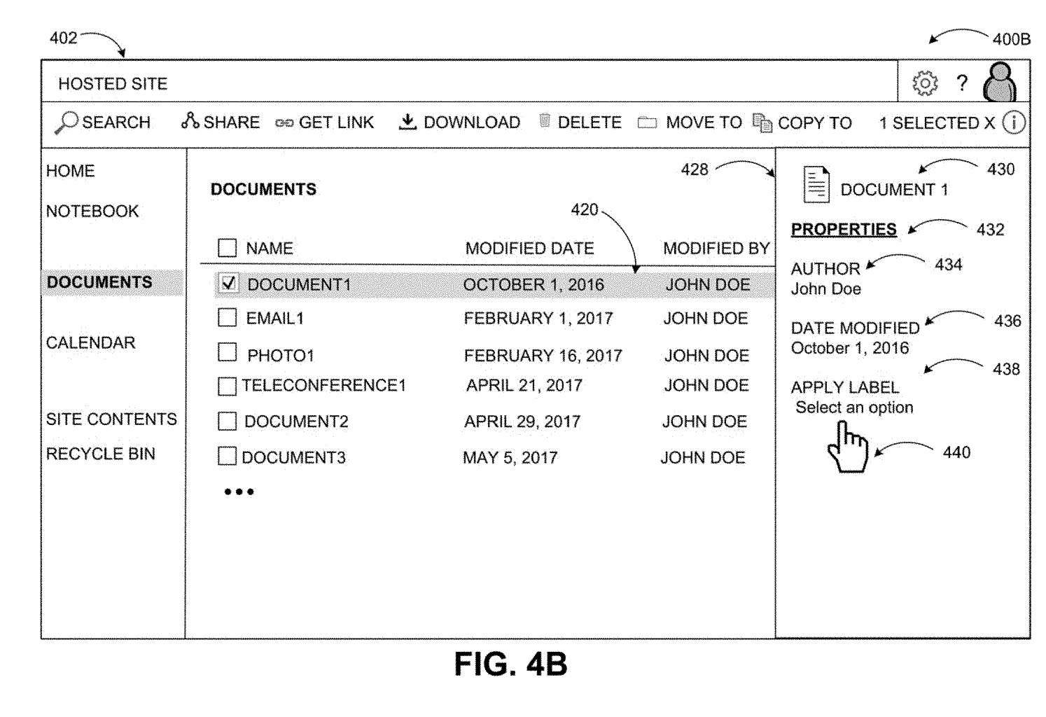

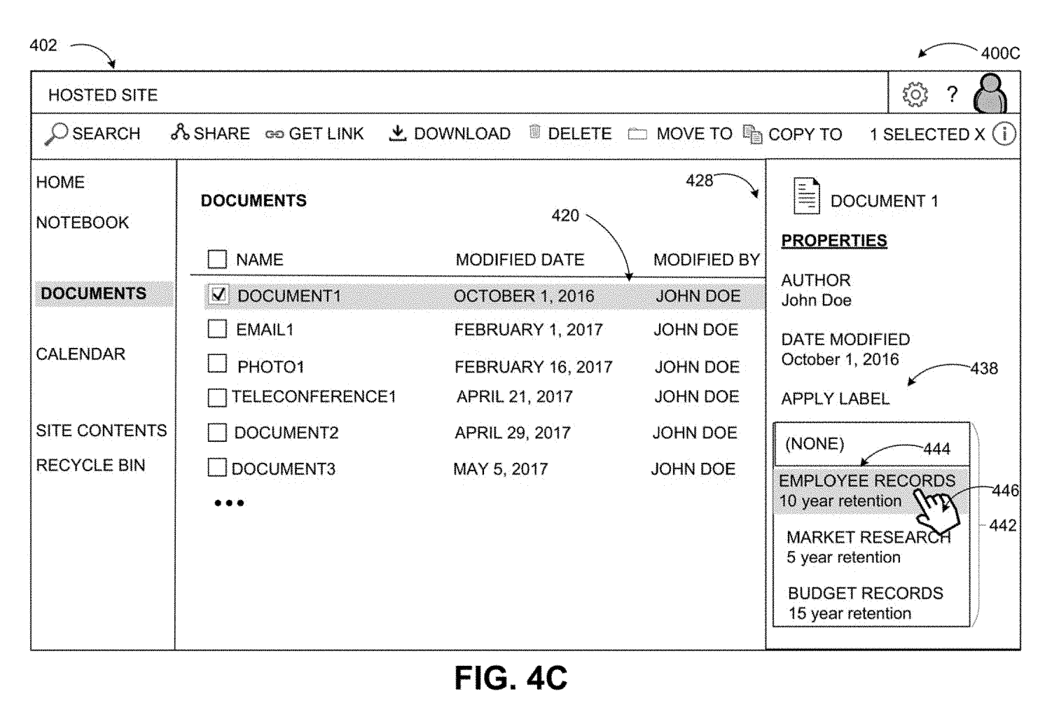

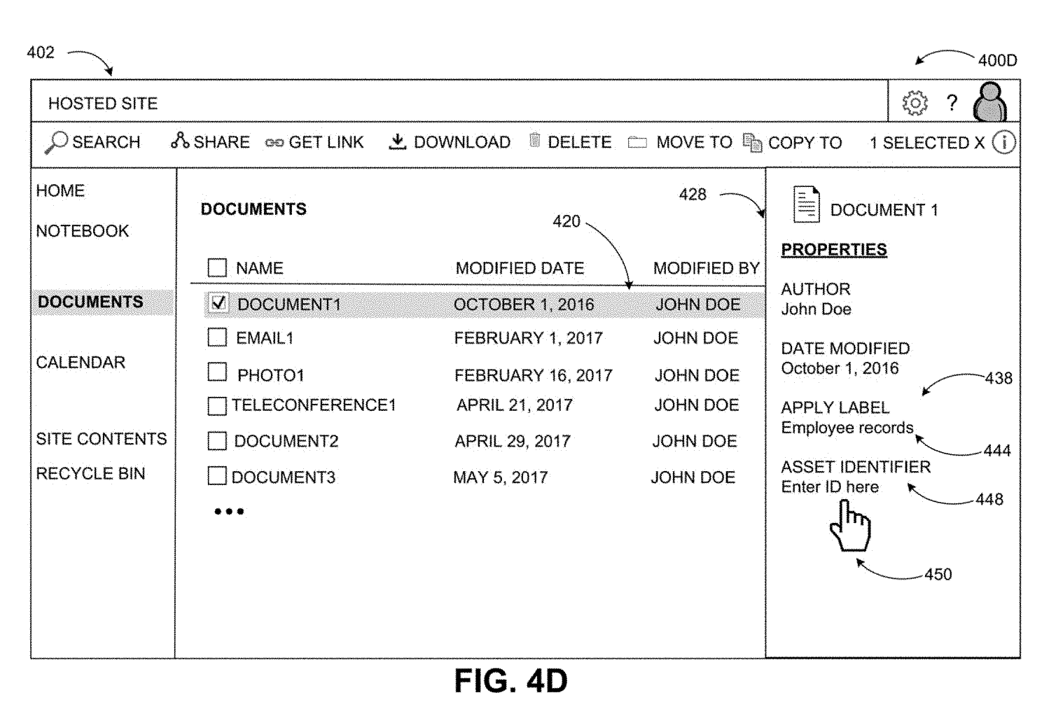

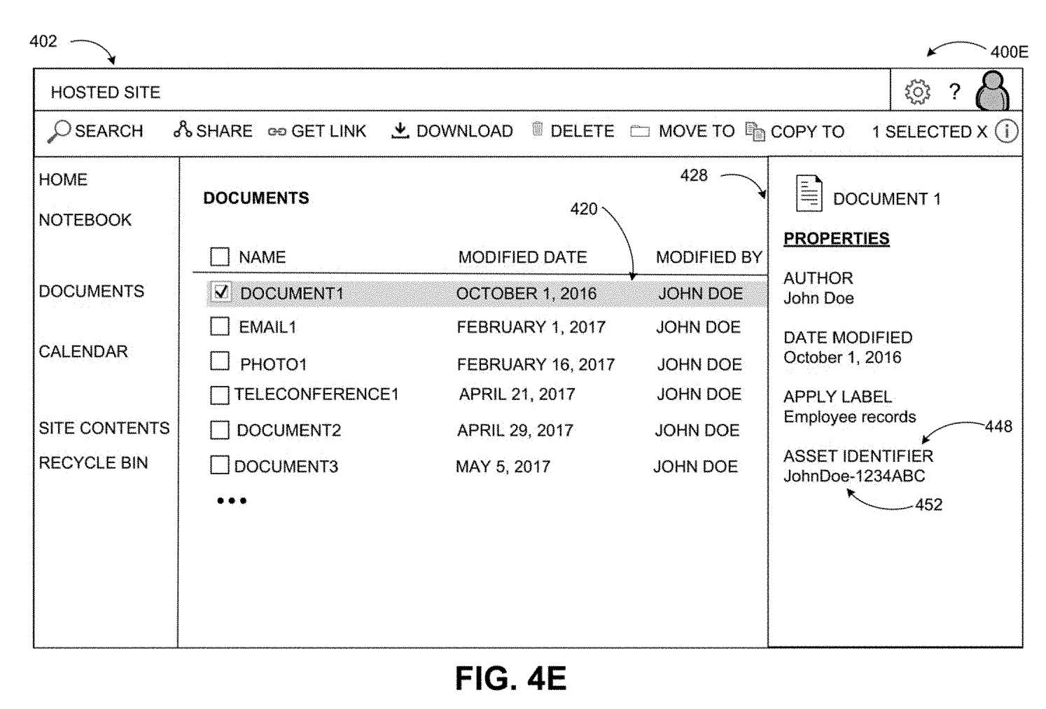

The hosted service 114 may be configured to publish the labels created such that the tenant administrator 104 may select one or more of the labels to apply to the items stored within the hosted service environment (as described in conjunction with FIGS. 4A-4E below). The items may include documents, personal records, communications such as entails, messages, and online conferences, and non-document content such as recordings, among other similar data. The items may be stored either locally to (e.g., within local storage 108 of the client devices 102) or remotely at data stores within the hosted service 144, at storage services configured to serve the hosted service 114, and/or at data stores of applications associated with the hosted service 114. In response to detecting selection of label(s) for application to an item, the hosted service 114 may be configured to prompt the tenant administrator 104 to provide an asset identifier associated with the item. The asset identifier may be an employee number, a project number, or other similar identification dependent on the item category of the label. For example, if the item category of the selected label is employee records, the asset identifier may be an employee number. For further example, if the item category of the selected label is Project X, the asset identifier may be the project number associated with project X. The hosted service may be configured to store the selected label(s) and the asset identifier as metadata of the item. The metadata may be indexed across the hosted service 114. As such, the hosted service and other systems and/or modules associated with the hosted service, such as the security and compliance system 118, may be able to associate the items with their respective labels and asset identifiers.

The security and compliance system 118 may be configured to detect an occurrence of a retention trigger event associated with a person or a project. A retention trigger event may include an employee's resignation or termination, a project's completion or termination, a legal event, or an organizational decision. Example legal events may include termination of a contract, agreement, permit, or license, intellectual property right expiration, claim resolution, or a bankruptcy settlement, among other examples. Example organizational decisions may include supersession of a policy, program, or procedure, closing of a customer account, a customer's last date of visit, payment of a loan, sale or disposition of a fixed asset, cessation of product manufacture, deactivation of a benefit plan, and/or supersession of job description, among other examples. In response, the security and compliance system 118 may be configured to query the items stored within the hosted service environment to determine items associated with an asset identifier that identifies the person or the project with whom the retention trigger event is associated. For example, if an employee is terminated (the retention trigger event), the query may determine all items associated with that employee's number (the asset identifier).

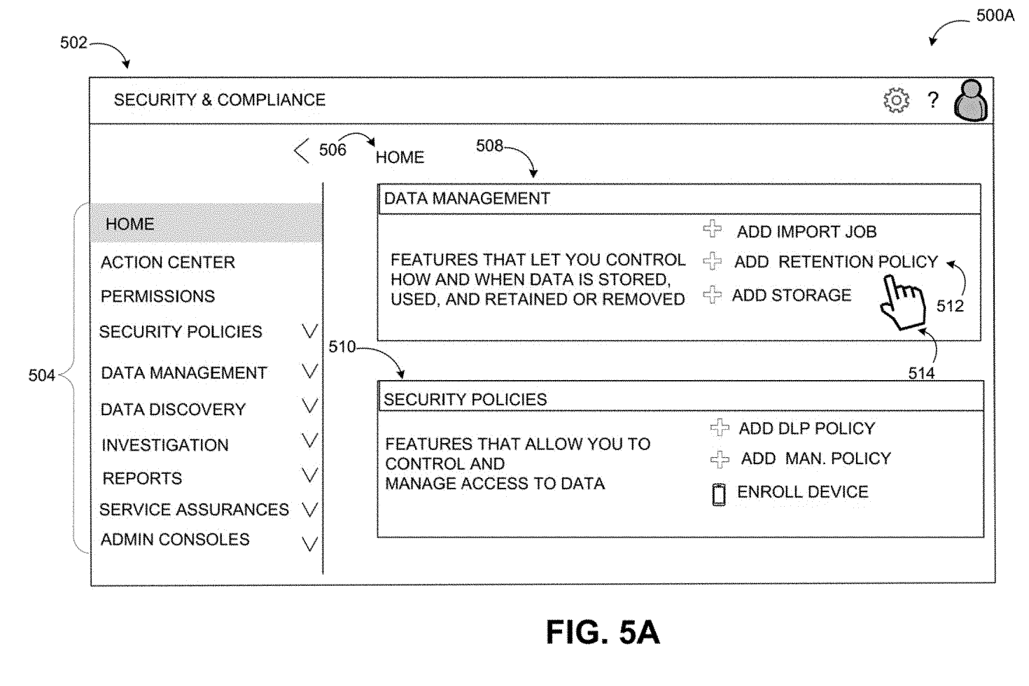

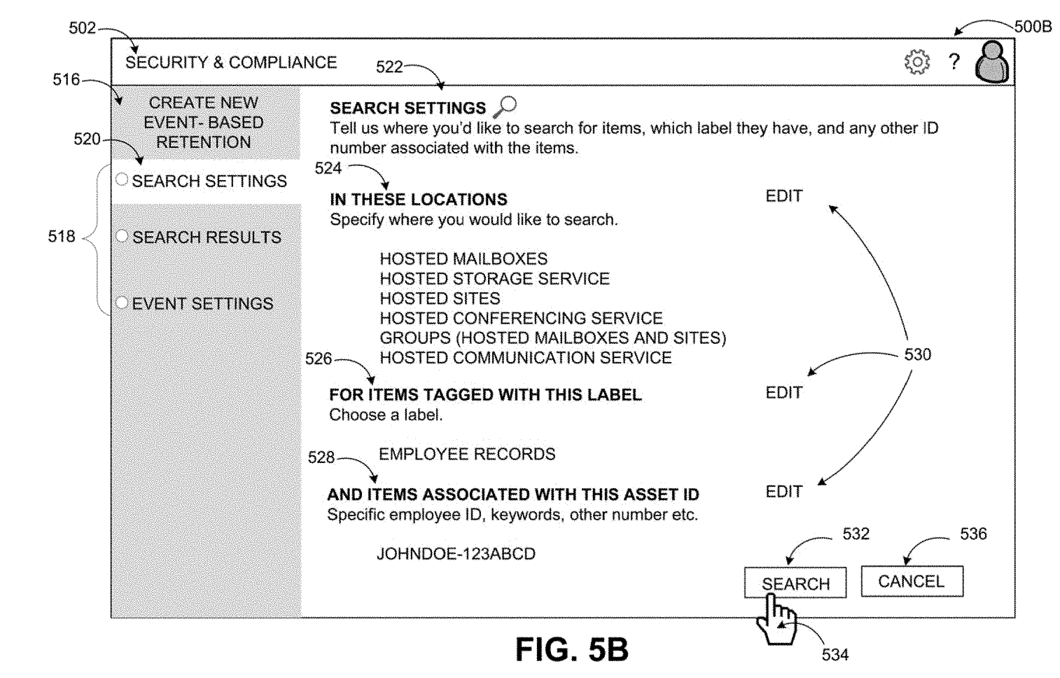

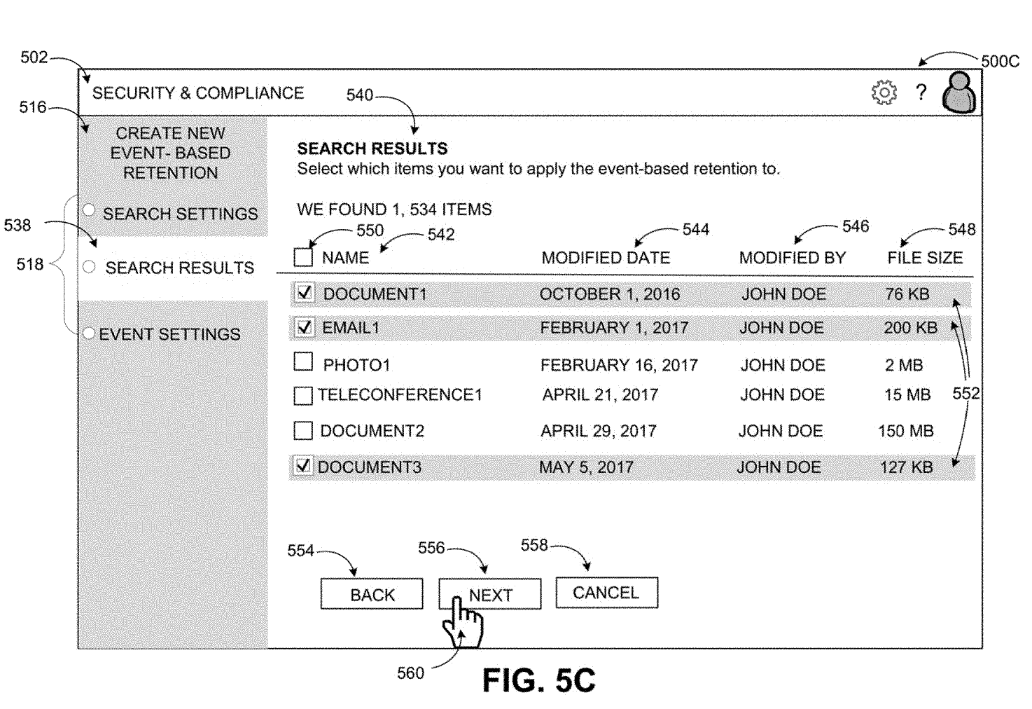

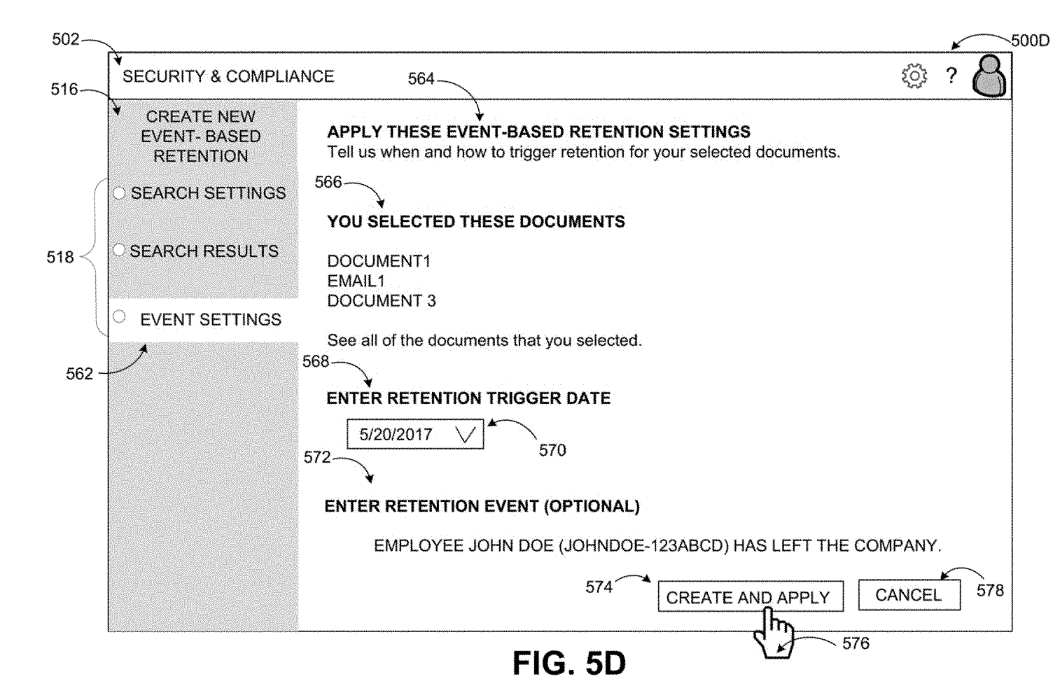

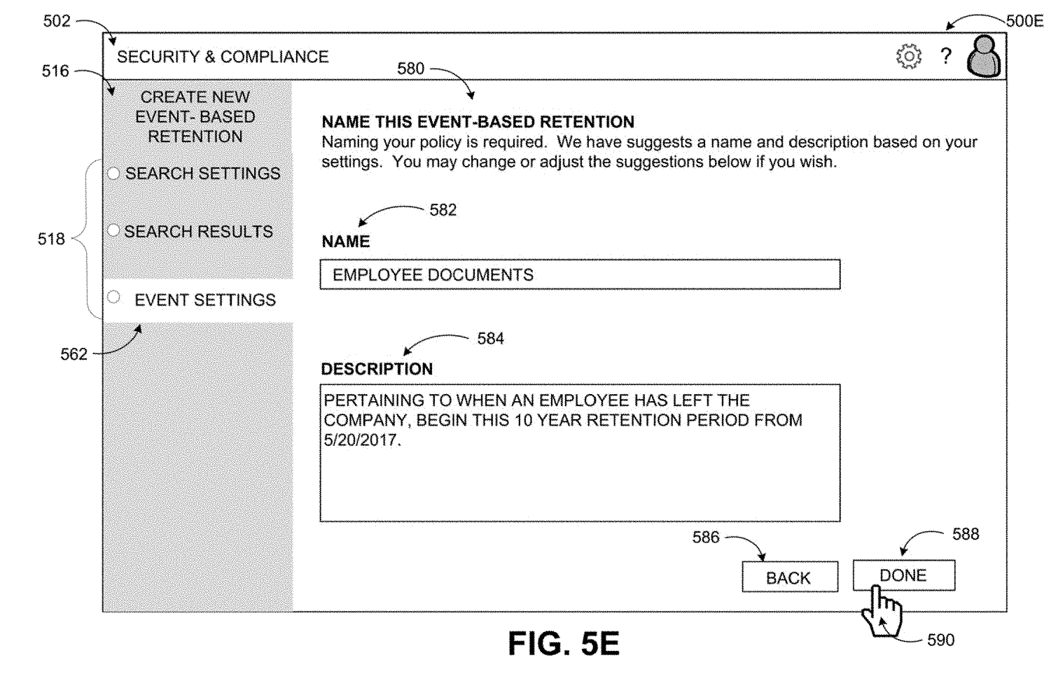

The security and compliance system 118 may be configured to detect the occurrence of the retention trigger event by receiving a notification through a communication, a record update, and/or manual input. In one example, the tenant administrator 104 may manually enter a label and the asset identifier to be used in the query through a dashboard of the security and compliance system 118 (as described in conjunction with FIGS. 5A-5E below). In another example, the security and compliance system 118 may be configured to check the tenant's human resource records weekly for employee status updates, where an update of an employee's status from “employed” to “resigned” or “terminated” indicates the occurrence of the retention trigger event of an employee's resignation or termination. The record update may include the employee's number (the asset identifier) to be used in the query.

Alternatively, a third party application associated with the hosted service 114 may be enabled to trigger the security and compliance system 118 to perform the query. For example, a human resources system may be associated with the hosted service 114, where the human resources system may be provided extensions to an application programming interface (API) of the hosted service 114. Therefore, if an employee is terminated and a human resources manager enters an employee number (an asset identifier) and a termination date of the employee through the human resources system, the human resources system will then trigger the security and compliance system 118 through the API to perform the query.

The security and compliance system 118 may query items stored at data stores within the hosted service 114, items stored at storage services configured to serve the hosted service 114, and/or items stored at data stores of applications associated with the hosted service 114, such as communication, productivity, and storage applications, to determine each item associated with the asset identifier. As previously discussed, the security and compliance system 118 may be configured to query the items to determine items associated with the asset identifier. In other embodiments, the query may also search for items comprising a particular item category/label in addition to the asset identifier. For example, the query may be search for item category/label “AND” asset identifier or search for item category/label “OR” asset identifier to avoid the risk of missing items of relevance that simply failed to include the asset identifier.

The security and compliance system 118 may then be configured to update or set the retention period and the retention type for each determined item based on a retention policy associated with each determined item. The retention policy may identify the retention period and the retention type based on the asset identifier, the item category, and the retention trigger event. For example, if an employee is terminated (the retention trigger event), a retention period of 10 years and a retention type of keep and delete may be set for each of the determined items that are associated with the employee number and fall under the item category “Employee Records.” The tenant administrator 104 may be enabled to modify the updated or set retention type and retention period.

In some examples, the determined items associated with the asset identifier returned as query results may fall under more than one item category (that is, the determined items may be associated with more than one label) causing the security and compliance system 118 to update or set the retention period and the retention type for each determined item based on different retention policies. For example, if the detected retention trigger event is the employee's termination, the query may determine items associated with the employee's number that fall under one or both of “Employee Records” and “Payroll Records” item categories/labels. The retention policy for each item may be different because items falling under the “Employee Records” item category may require a longer retention period than items falling under “Payroll Records” item category, for example.

An update and/or set of the retention periods and types to each determined item may be rolled back or paused in response to a determination that the asset identifier was incorrect. For example, if the asset identifier was incorrectly entered when manually input by the tenant administrator 104 or if the security and compliance system 118 erroneously detected the occurrence of the retention trigger event. For example, if an employee's status was updated in a the tenant's human resources records from “employed” to “on medical leave”, and the security and compliance system 118 identified an update of the employee's status to be equivalent to the retention trigger event of an employee's resignation or termination.

In additional embodiments, various types of reports may be generated by the security and compliance system 118. For example, a report may be generated to determine all retention trigger events present within the hosted service environment. For each retention trigger event, the report may include an event name, an event description, an item category, an associated asset identifier, an event, date, affected labels, a status, a count of a number of items affected by the retention trigger event, an original creation date of the retention trigger event, a retry date, and/or a count of a number of items deleted by the retention trigger event. Additionally, a report may be generated to determine items stored within the hosted service affected by a past, present, or a future retention trigger event. Further, a report may be generated to determine a list of applied retention policies that failed.

As previously discussed, in the field of data management, a lifecycle of an item, such as a document or a communication, is controlled based on a type of the item. Particular types of items may be required by law, industry regulation, or organizational policies and procedures to be retained for a defined period of time. Currently implemented methods and systems are focused on property based data retention, where retention policies are applied to items based on properties of the items, such as a date the item was created or modified, or an author of the item. However, many required data retention policies are not triggered by item properties, but instead by events, such as the employee leaving the company. Embodiments as described herein provide event triggered data retention. Event triggered data retention may increase organizational compliance and user efficiency by utilizing item labels to ensure all items pertinent to the retention policy can be gathered quickly from one query. Additionally, the user friendly interfaces provided by the hosted service and/or security and compliance system to the tenant administrator for both label association and creation of event based retention policies improve user interactivity.

Embodiments, as described herein, address a need that arises from a very large scale of operations created by software-based services that cannot be managed by humans. The actions/operations described herein are not a mere use of a computer, but address results of a system that is a direct consequence of software used as a service offered in conjunction with a large numbers of devices and users using hosted services.

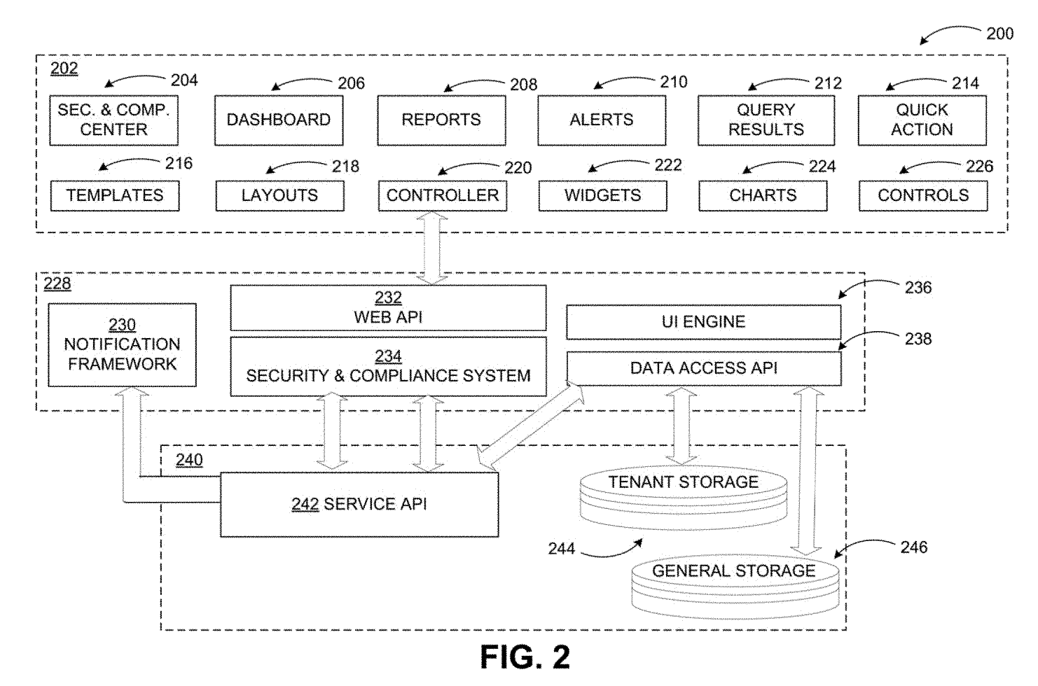

FIG. 2 includes a display diagram illustrating an example architecture of a system to provide event triggered data retention.

In some examples, a hosted service may allow access to its services through a client application 202. As shown in a diagram 200, the client application 202 may display a user interface enabling a tenant, administrator, or user to interact with a security and compliance center 204 associated with protection aspects of a system or organization, such as malicious attack mitigation, data protection, and policy configuration and enforcement (including retention policy configuration and enforcement), for example. The user interface may be a dashboard 206, through which the tenant, administrator, or user may, among other actions, create, apply, and update event triggered data retention policies to items stored within the hosted service environment based on query results 212, where the query is performed in response to detecting an occurrence of a retention trigger event. The dashboard 206 may also provide reports 208, alerts 210, and quick action options 214 with which the tenant, administrator, or user may interact. The dashboard 206 may have attributes such as templates 216, layouts 218, widgets 222, charts 224 and controls 226 that may be customized.

A dashboard controller 220 may interface with a server 228 through a web application programming interface (API) 232. Calls may be sent back and forth from the server 228 to the client application 202 based on what should be displayed through the dashboard 206. For example, in response to detecting an occurrence of a retention trigger event associated with a person or a project, a security and compliance system 234 may query items stored within the hosted service environment to determine each item comprising an asset identifier that identities the person or the project. A call may sent through the web API 232 to display the query results 212 through the dashboard 206 in a manner determined by the user interface (UI) engine 236. The server 228 may host a notification framework 230 configured to determine tenants, administrators, and/or users to be notified of retention trigger events, policy suggestions, alerts, and reports, among other examples, and how those notifications should be delivered.

A data access API 238 hosted by the server 228 may interface with backend storage systems 240. The backend storage systems 240 may include tenant storage 244 and general storage 246, for example. The backend storage systems 240 may also include a service API 242 that interfaces with the security and compliance system 234, the notification framework 230, and data that is being retrieved by the data access API 238 from the tenant storage 244 and general storage 246 to allow exchange.

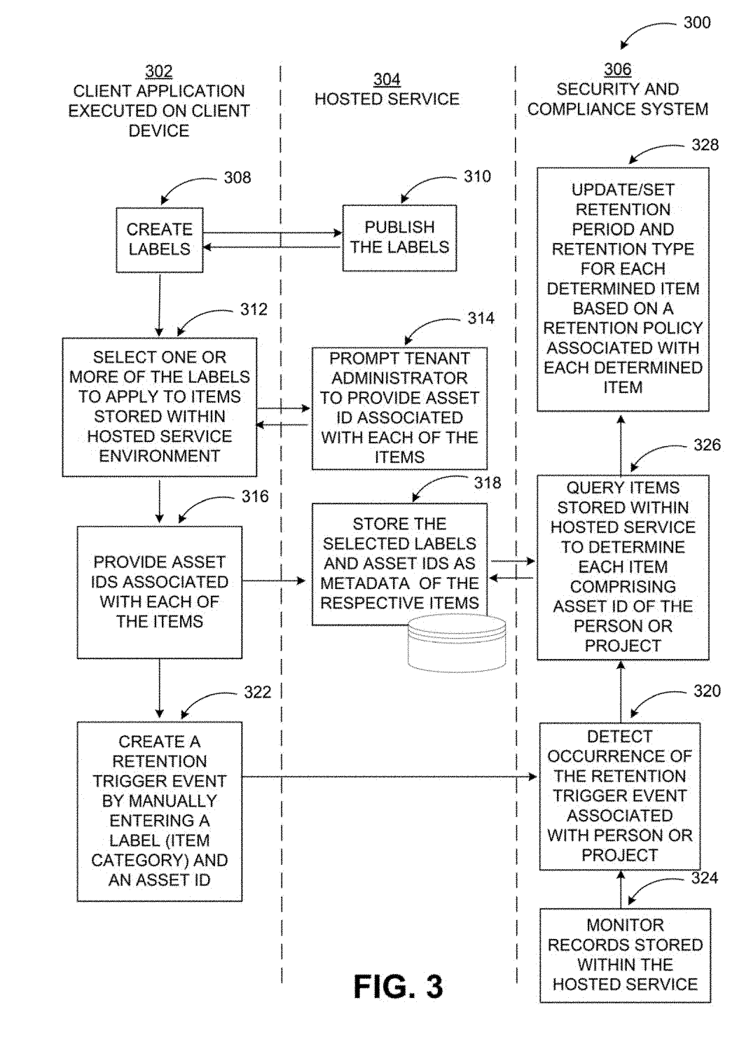

FIG. 3 includes a display diagram illustrating conceptually an example set of actions and components for providing event triggered data retention.

As shown in a diagram 300, a tenant administrator or another user with a similar role, permissions or credentials may interact with a hosted service 304 for the tenant through a client application 302 that is associated with the hosted service and executed on a client device. The hosted service 304 may include a security and compliance system 306 and/or the security and compliance system 306 may be an integral module of another service, such as a protection service, configured to serve the hosted service 304.

The administrator may be prompted to create a plurality of labels 308 through a user interface of the client application 302 that may be applied to items stored within the hosted service environment as the items are created, modified, and/or deleted. Each label may define an item category, a retention type, a retention period, and a retention trigger. The item category may describe a general type of information or data contained within the item, the retention type may indicate a manner in which the item is to be retained, the retention period may be a time period required by law, industry regulation, or organizational policies and procedures to retain the item based on item category, and the retention trigger may be a creation date, a last modified date, a label date, or an event date. In some embodiments, some of these elements defined by the label may be automatically defined by organizational defaults of the tenant. To provide an example, the tenant administrator may create, among other labels, a label for application to items associated with the tenant's patent rights. The item category for the label may be defined as patent records, the retention type may be defined as mark as inactive or locked, the retention period may be defined as 10 years, and the retention trigger may be defined as an event date, where the retention period set for that item will begin on the date that a retention trigger event occurs. In this example, the retention trigger event is the expiration of the patent rights.

The hosted service 304 may be configured to publish the labels 310 such that the tenant administrator may be able to select one or more of the labels to apply to the items stored within the hosted service environment 312 through the user interface of the client application 302. For each published label, the defined item category may also serve as a name to help the administrator or other users to quickly identify which label(s) should be selected for the item. Continuing the example above, the name for the label may be “Patent Records” based on the defined item category to allow the administrator to quickly determine the items to which that label should be applied to (i.e., items associated with the tenant's patent). The items to which the labels may be applied may include documents, personal records, communications such as emails, messages, and online conferences, and non-document content such as recordings, among other similar data.

In response to detecting selection of label(s) for application to the items, the hosted service 304 may be configured to prompt the tenant administrator to provide an asset identifier associated with each of the items for which labels were selected 314. Continuing the example above, the asset identifier may be an application number or a patent number. The tenant administrator may provide the asset, identifiers associated with each of the items for which labels, were selected 316 to the hosted service 304 through the user interface of the client application 302. Upon receipt, the hosted service 304 may be configured to store the asset identifiers and the selected label(s) as metadata of the respective items 318. The metadata may be indexed across the hosted service 304. As such, the hosted service and other systems and/or modules associated with the hosted service (e.g., the security and compliance system 306) may be able to associate the items with their respective labels and asset identifiers.

The security and compliance system 306 may be configured to detect an occurrence of a retention trigger event associated with a person or project 320. In one embodiment, the occurrence of the retention trigger event may be detected in response to the administrator manually entering a label, which defines an item category, and an asset identifier 322 that identifies the person or project with whom the retention trigger event is associated through the user interface of the client application 302. In response, the security and compliance system 306 may be configured to query the items stored within the hosted service environment 326 to determine each item comprising the asset identifier manually entered by the administrator. In some embodiments, the query may also search for items comprising the item category of the label in addition to the asset identifier. For example, the query may be search for item category “AND” asset identifier or search for item category “OR” asset identifier to avoid the risk of missing items of relevance that simply failed to include the asset identifier. Continuing the example above, the administrator may manually enter the label “Patent records” and the patent application number as the asset identifier causing the security and compliance system 306 to query items stored within the hosted service environment for items with metadata comprising an the patent application number (and optionally items comprising the patent application number and/or the patent application number). The security and compliance system 306 may then be configured to update or set the retention period and the retention type for each determined item based on a retention policy associated with each determined item 328. The retention policy may identify the retention period and the retention type based on the asset identifier, the item category, and the retention trigger event.

In another embodiment, the security and compliance system 306 may be configured to monitor records stored within the hosted service 324. The security and compliance system 306 may detect the occurrence of the retention trigger event associated with the person or project 320 upon receiving a notification of a record update based on the monitoring. The notification may include the asset identifier associated with the person or project with whom the detected retention trigger event is associated. In response, the security and compliance system 306 may be configured to query the items stored within the hosted service environment 326 to determine each item comprising the asset identifier. The security and compliance system 306 may then be configured to update or set the retention period and the retention type for each determined item based on a retention policy associated with each determined item 328.

FIGS. 4A through 4E include display diagrams illustrating an example user interface through which a label may be selected for application to an item stored within the hosted service environment. A hosted service may provide productivity, communication, cloud storage, collaboration, and comparable services to a tenant. A tenant administrator or another user with a similar role, permissions, or credentials may interact with the hosted service through an application that is associated with the hosted service, for example. The hosted service may execute a thin (e.g., a web browser) or a thick (e.g., a locally installed client application) version of the application through a device associated with the tenant administrator.

As previously discussed, the tenant administrator may create a plurality of labels, where each label may define an item category, a retention type, a retention period, and a retention trigger. The hosted service may be configured to publish the labels such that the tenant administrator may be able to select one or more of the labels to apply to the items stored within the hosted service environment as the items are created, modified or deleted.

As shown in a diagram 400A of FIG. 4A, a user interface 402 of the application may display a site of the hosted service, where the site provides central storage and a collaboration space for the tenant's items stored within the hosted service environment. The user interface 402 may include a plurality of tabs 404 to help the administrator navigate to content of the site. For example, the administrator may select an items tab 406 to view items stored within the site. The items may include documents, personal records, or communications such as emails, messages, and online conferences, and non-document content such as recordings, among other similar data. In response to the selection of the items tab 406 an items view 408 may be presented along with a tool bar 410 to enable the administrator to efficiently interact with the items presented. The tool bar 410 may include options to share, get links for, download, delete, move, or copy one or more of the items. The items may be presented in a table-like format comprising at least a name column 412, a modified date column 414, and a modified by column 416, where each row is represented by an item. There may also be a select all feature 418 to enable the administrator to more conveniently select one element rather than each individual item if all items within the site are to be selected.

When the administrator selects an item 420 from the item view page 408, the tool bar 410 may be updated to indicate that there has been on selected 422. An information icon 424 may be played in conjunction with the update. In response to the administrator's selection of the information icon 424 through a double click or tap action 426, for example, an information user interface element 428 may be displayed through the user interface 402, as shown in a diagram 400B of FIG. 4B. The information user interface element 428 may include a name 430 of the selected item 420 and properties 432 of the selected item 420. The properties 432 may include an author 434 of the selected item 420 and a last modified date 436 of the selected item 420. An option to apply a label 438 to the selected item 420 may also be displayed.

In response to the administrator's selection 440 of the option to apply a label 438, a label selection menu 442 may be displayed through the user interface 402 as shown in a diagram 400C of FIG. 4C. The label selection menu 442 may include one or more of the labels created by the tenant administrator and published by the hosted service. For example, one label 444 within the label selection menu 442 may include an “Employee Records” label. The label 444 may define an item category of employee records, a retention type of keep and delete, a retention period of 10 years, and a retention trigger of an event date (meaning the retention period set for that item will begin on the date that a retention trigger event occurs, such as the date of an employee's resignation or termination). If the selected item 420 is a document comprising employee information, such as an employee's W2 form, the tenant administrator may select 446 the label 444 from the label selection menu 442 to apply to the selected item 420.

The hosted service may then be configured to provide a prompt 448 through the user interface 402 for the administrator to input an asset identifier associated with the selected item 420 to which the label 444 was applied, as shown in a diagram 400D of FIG. 4D. The administrator may select 450 the prompt 448 and enter the asset identifier 452 as shown in a diagram 400E of FIG. 4E. The asset identifier 452 may be an employee number of the employee whose W2 is contained within the selected item 420, for example.

FIGS. 5A through 5E include display diagrams illustrating an example dashboard of a security and compliance system through which event triggered data retention policies may be created and applied.

A hosted service may provide productivity, communication, cloud storage, collaboration, and comparable services to a tenant. A tenant administrator or another user with a similar role, permissions, or credentials may interact with the hosted service to, among other things, create or update a plurality of labels, where each label may define an item category, a retention type, a retention period, and a retention trigger. The hosted service may be configured to publish the labels such that the administrator may be able to select and/or update one or more of the labels to apply to items stored within the hosted service environment as the items created, modified, or deleted. Selected labels and asset identifiers identifying a person or project associated with each item may be stored as metadata of the respective items, where the metadata is indexed across the hosted service. As such, the hosted service and other systems and/or modules associated with the hosted service (e.g., a security and compliance system) may be able to associate the items with their respective labels and asset identifiers. The security and compliance system may be an integral module of the hosted service or an integral module of a separate protection service configured to serve the hosted service.

As shown in a diagram 500A of FIG. 5A, an application may provide the administrator access to a user interface, such as a dashboard 502, associated with the security and compliance system. The dashboard 502 may present summary and/or detailed information associated with threats, security and compliance configurations, analyses results, and configuration controls, for example. Among other things, the dashboard 502 may comprise a plurality of tabs 504 that each offer one or more security and compliance-based features that may be managed by the administrator through the dashboard 502. Example tabs 504 may include a home dashboard view 506, an action center, permissions, security policies, data management, data discovery, investigation, reports, service assurances, and administrative consoles.

The home dashboard view 506 may enable the administrator to quickly create, enable, or manage data 508 and security policies 510. Among other aspects of data management, the administrator may select 514 to add a data retention policy 512. In an example scenario, the tenant may be an organization and an employee of the organization may have resigned from his or her position on May 20, 2017 (a retention trigger event). Therefore, the tenant administrator may need to initiate event-based data retention on all items associated with the resigned employee to ensure that each of those items is retained in accordance with the law, industry regulation, and/or the organization's policies and procedures. In response to the selection 514, an event-based data retention page 516 of the dashboard 502 may be displayed, as shown in diagram 500B of FIG. 5B. The event-based data retention page 516 may include a plurality of tabs 518 associated with implementing event-based data retention.

A first of the tabs 518 may be a search settings tab 520 that when selected provides a search settings view 522. The search settings view 522 may prompt the administrator to select locations 524 within the hosted service environment in which to query for items tagged with a particular label 526 and associated with a particular asset identifier 528. The selections may be made or edited at any time during the creation process using the edit control elements 530. Continuing with the example scenario, the administrator will want to select locations in which any items associated with the resigned employee may be stored, a label with an item category associated with employment type records, and an asset identifier that identifies the resigned employee, such as an employee number. For example, the administrator may select for the compliance and security system to, search mailboxes, a storage service, sites, a conferencing service, groups (including mailboxes and sites), and a communication service that are hosted by the hosted service for items that are tagged with the label “Employee Records” and associated with employee number “John Doe-123ABCD,” as illustrated.

Upon administrator selection 534 of a search control element 532 of the search settings view 522, the compliance and security system may be configured to perform the query. In some embodiments, the query is performed such that the items searched for are those both tagged with the particular label 526 and associated with the particular asset identifier 528. However, performing this type of query runs the risk of missing items of relevance that simply failed to include the asset identifier. Therefore, in other embodiments, the query may be performed such that the items searched for are those either tagged with the particular label 526 or associated with the particular asset identifier 528. In further embodiments, the query may be performed such that the items searched for are just those associated with the particular asset identifier 528. This may be the case if multiple labels yield relevant items associated with the resigned employee based on the retention trigger event such that only one query versus multiple individual label plus asset identifier queries need to be performed. The administrator may alternatively select a cancel control element 536 if the administrator no longer desires to create and apply an event-based retention policy.

A second of the tabs 518 may be a search results tab 538 that provides a search results view 540, as shown in a diagram 500C of FIG. 5C. The search results view 540 may provide the results of the query performed by the security and compliance system and prompt the administrator to select items to which the event-based retention will be applied to. The query results may be displayed in a table-like format comprising at least a name column 542, a modified date column 544, a modified by column 546, and a file size column 548, where each row is represented by an item that matched the query criteria (i.e., an item that was tagged with the particular label 526 and associated with the particular asset identifier 528). There may also be a select all feature 550 to enable the administrator to more conveniently select one element rather than each individual item if all items are to be selected for application of the event base retention. If the asset identifier is not associated with any item stored within the hosted service environment, an error message may be displayed in place of the table. If the administrator made an error in or would otherwise like to adjust his or her initial selection of search requirements, the administrator may select a back control element 554 to return to the search settings view 522, or if the administrator no longer desires to create and apply an event-based retention policy, the administrator may select a cancel control element 558. Otherwise, the administrator may select 560 one or more items 552 to which the event-based retention will be applied to and the next control element 556.

A third of the tabs 518 may be an event settings tab 562 that provides an event settings view 564, as shown in a diagram 500D of FIG. 5D. The event settings view 564 may prompt the administrator to apply an event-based retention policy to the selected items 552 by allowing the administrator to confirm 566 the selected items 552, enter a retention trigger date 568 through a provide date picker element 570, and provide an optional justification 572 for the application of the event-based retention policy. Continuing with the example scenario, the administrator may enter the date of the employee's resignation, May 20, 2017, into the date picker element 570 as the retention trigger date 568 and include as the justification 572 that the event based retention policy is being applied because the employee left the company on May 20, 2017. The administrator may then select 576 a create and apply control element 574 to create and apply the event-based retention event based-retention policy. The administrator may alternatively select a cancel control element 578 if the administrator no longer desires, to apply and create the event-based retention policy.

The event settings tab 562 may also be configured to provide an event naming view 580 that prompts the administrator to name and describe the created event based-retention policy, as shown in a diagram 500E of FIG. 5E. A name text box 582 and a description text box 584 may be provided within the event naming view 580. In some embodiments, the security and compliance system may populate the name text box 582 and the description text box 584 with suggested names and descriptions, respectively. For example, the security and compliance system may suggest a name that closely corresponds to the label selected as query criteria and a description that closely corresponds to the justification, if provided, for the event-based retention. The administrator may select 590 a done control element 588 to accept the suggested name and description and/or after the administrator has modified the suggested name and description as needed. Alternatively, if the administrator made an error in or would otherwise like to adjust his or her selection of documents, retention trigger date, or justification, the administrator may select a back control element 586 to return to the event settings view 564.

The examples provided in FIGS. 1A through 5E are illustrated with specific systems, services, applications, and user interface displays. Embodiments are not limited to environments according to these examples. Event triggered data retention may be implemented in environments employing fewer or additional systems, services, applications, and user interface displays. Furthermore, the example systems, services, applications, and user interface displays shown in FIG. 1A through 5E may be implemented in a similar manner with other user interface or action flow sequences using the principles described herein.

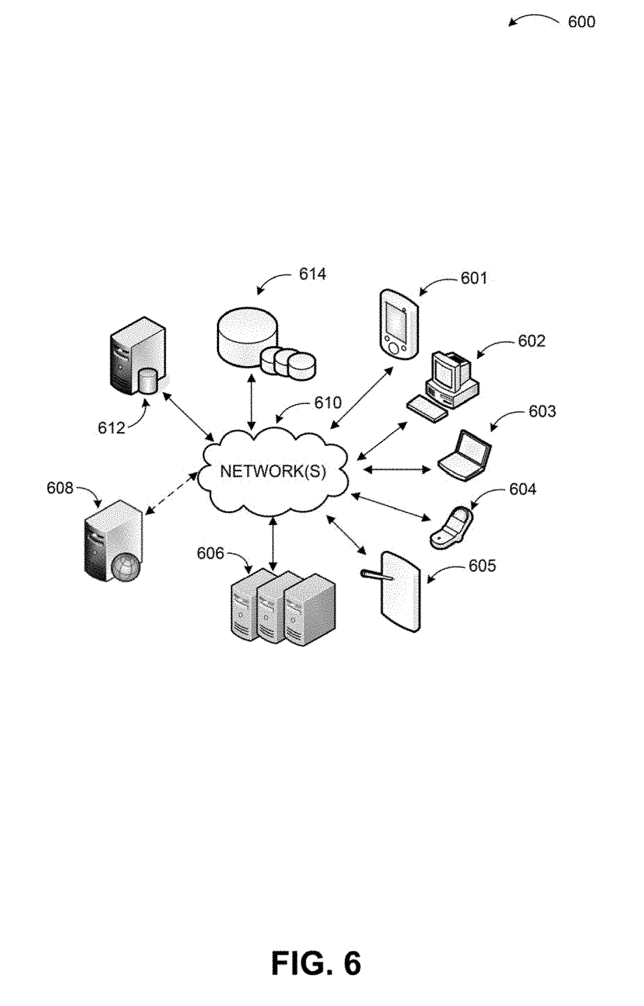

FIG. 6 is a networked environment, where a system according to embodiments may be implemented. A security and compliance system as described herein may be employed in conjunction with hosted applications and services (for example, the client application 106 associated with the hosted service 114, the hosted service 114, or the protection service 122) that may be implemented via software executed over one or more servers 606 or individual server 608, as illustrated in diagram 600. A hosted service or application may communicate with client applications on individual computing devices such as a handheld computer 601, a desktop computer 602, a laptop computer 603, a smart phone 604, a tablet computer (or slate), 605 (‘client devices’) through network(s) 610 and control a user interface, such as a dashboard, presented to users.

Client devices 601-605 are used to access the functionality provided by the hosted service or client application. One or more of the servers 606 or server 608 may be used to provide a variety of services as discussed above. Relevant data may be stored in one or more data stores (e.g., data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed to provide event triggered data retention. Furthermore, the networked environments discussed in FIG. 6 are for illustration purposes only. Embodiments are not limited to the example applications, engines, or processes.

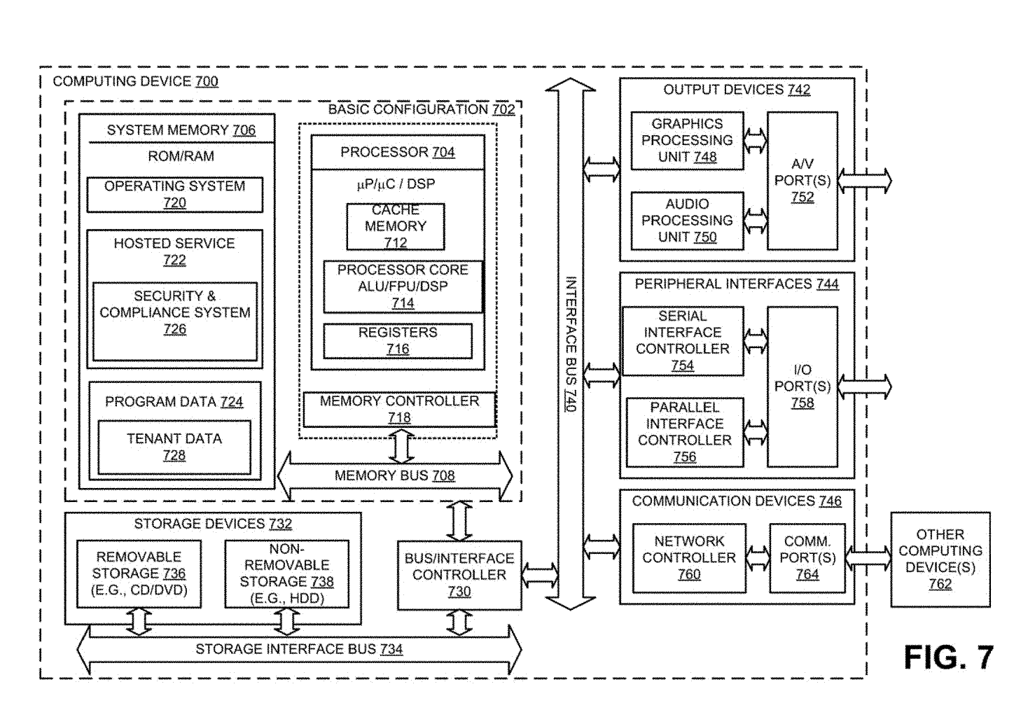

FIG. 7 is a block diagram of an example a computing device, which may be used to provide event triggered data retention.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a hosted service 722, and program data 724. The hosted service 722 may include a security and compliance system 726, which may be an integrated module of the hosted service 722. The security and compliance system 726 may be configured to associate an item stored in a hosted service environment with a label defining an item category, a retention type, a retention period, and/or a retention trigger, and detect an occurrence of a retention trigger event associated with a person or a project. In response, the security and compliance system 726 may be configured to query items stored within the hosted service environment to determine the item associated with an asset identifier that identifies the person or the project, and update or set the retention period and the retention type for the item based on a retention policy associated with the item. The program data 724 may include, among other data, tenant data 728, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide event triggered data retention. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

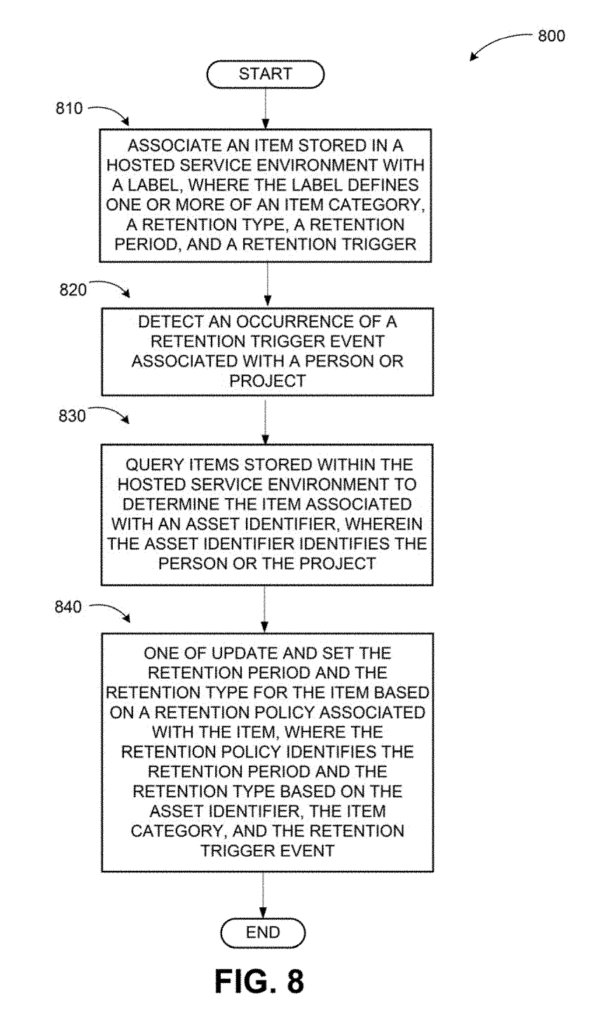

FIG. 8 illustrates a logic flow diagram of a method to provide event triggered data retention. Process 800 may be implemented on a computing device, server, or other system. An example server may comprise a communication interface to facilitate communication between another server configured to provide a hosted service environment for a tenant, one or more client devices, and the server. The example server may also comprise a memory to store instructions, and one or more processors coupled to the memory. The processors, in conjunction with the instructions stored on the memory, may be configured to provide event triggered data retention.

Process 800 begins with operation 810, where an item stored in a hosted service environment may be associated with a label. The label may define an item category, a retention type, a retention period, and/or a retention trigger. The item category may describe a general type of information or data contained within the item, the retention type may indicate a manner in which the item is to be retained, the retention period may be a time period required by law, industry regulations, or organizational policies and procedures to retain the item based on item category, and the retention trigger may be a creation date, a last modified date, a label date, or an event date.

At operation 820, the security and compliance system may be configured to detect an occurrence of a retention trigger event associated with a person or a project. The occurrence may be detected by receiving a notification through a communication, a record update, and/or manual input from a tenant administrator or user with a similar role, permissions, or credentials. The retention trigger event may include an employee's resignation or termination, a project's completion or termination, a legal event, or an organizational decision, for example.

At operation 830, in response, the security and compliance system may be configured to query items stored within the hosted service environment to determine the item associated with an asset identifier, where the asset identifier may identify the person or the project with whom the retention trigger event is associated. The asset identifier may be an employee number or project number, for example, that was included within the notification. The security and compliance system may query items stored at data stores within the hosted service, items stored at storage services configured to serve the hosted service, and/or items stored at data stores of applications associated with the hosted service.

At operation 840, the security and compliance system may then be configured to update or set the retention period and the retention type for the item based on a retention policy associated with the item. The retention policy may identify the retention period and the retention type based on the asset identifier, the item category, and the retention trigger event.

The operations included in process 800 are for illustration purposes. Event triggered data retention may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing event triggered data retention is described. The means may include a means for associating an item stored in a hosted service environment with a label, where the label defines one or more of an item category, a retention type, a retention period, and a retention trigger; a means for detecting an occurrence of a retention trigger event associated with a person or a project; a means for querying items stored within the hosted service environment to determine the item associated with an asset identifier, where the asset identifier identifies the person or the project; and a means for one of updating and setting the retention period and the retention type for the item based on a retention policy associated with the item, where the retention policy identifies the retention period and the retention type based on the asset identifier, the item category, and the retention trigger event.

According to some examples, a method to provide event triggered data retention is described. The method may include associating an item stored in a hosted service environment with a label, where the label defines one or more of an item category, a retention type, a retention period, and a retention trigger; detecting an occurrence of a retention trigger event associated with a person or a project; querying items stored within the hosted service environment to determine the item associated with an asset identifier, where the asset identifier identifies the person or the project; and one of updating and setting the retention period and the retention type for the item based on a retention policy associated with the item, where the retention policy identifies the retention period and the retention type based on the asset identifier, the item category, and the retention trigger event.

According to other examples, the retention trigger may be one of a creation date, a last modified date, a label date, and an event date. The retention trigger event may be one of a person's resignation or termination, a project's completion or termination, a legal event, and an organizational decision. The retention type may be one or more of keep, keep and delete, delete, move to a secure storage, lock against editing, mark as inactive or locked, and make inaccessible to a group of users. Detecting the occurrence of the retention trigger event may include receiving a notification through a communication, a record update, or a manual input. The notification may include the asset identifier to be used in the query.

According to further examples, the method may include prompting a creation or update of the label upon creation or modification of the item, where one or more of the item category, the retention type, the retention period, and the retention trigger defined by the label are automatically defined based on organizational defaults. The method may also include prompting provision of the asset identifier of the item upon the creation or update of the label for the item, where the asset identifier is stored as metadata of the item. The item may be a document, a personal record, a communication, or non-document content. Querying the items stored within the hosted service environment to determine the item associated with the asset identifier may include querying items stored at data stores within a hosted service, items stored at storage services configured to serve the hosted service, and items stored at data stores of applications associated with the hosted service. The method may further include allowing an administrator to modify the updated or set retention type and retention period. The method may also include storing the label as metadata of item.

According to other examples, a server configured to execute a security and compliance system to provide event triggered data retention is described. The server may include a communication interface configured to facilitate communication between another server configured to provide a hosted service environment for a tenant, one or more client devices, and the server; a memory configured to store instructions; and one or more processors coupled to the communication interface and the memory. The processors may associate an item stored in the hosted service environment with a label, where the label defines one or more of an item category, a retention type, a retention period, and a retention trigger; detect an occurrence of a retention trigger event associated with a person or a project by receiving a notification through a communication, a record update, or a manual input; query items stored within the hosted service environment to determine the item associated with an asset identifier, where the asset identifier identifies the person or the project and is included in the notification; and one of update and set the retention period and the retention type for the item based on a retention policy associated with the item, where the retention policy identifies the retention period and the retention type based on the asset identifier, the item category, and the retention trigger event.

According to some examples, the processors may also roll back or pause the update or set of the retention period and the retention type for the item in response to a determination that the asset identifier was incorrect. The processors may further provide to be displayed an error message in response to a determination that the asset identifier is not associated with any item stored within the hosted service environment. The one or more processors may generate one or more reports, where the one or more reports include a report to determine retention trigger events present within the hosted service environment, and a report to determine items stored within the hosted service affected by a past, present, or a future retention trigger event. The security and compliance modulo: may be an integral module of the hosted service; an integral module of a client application locally installed on the one or more client devices; or a separate module associated with a protection service.

According to farther examples, a system configured to provide event triggered data retention is described. The system may include a first server configured to provide a hosted service environment for a tenant; and a second server configured to execute a security and compliance system. The second server may include a communication interface configured to facilitate communication between the first server and the second server; a memory configured to store instructions; and one or more processors coupled to the communication interface and the memory. The one or more processors may associate an item stored in the hosted service environment with a label, where the label defines one or more of an item category, a retention type, a retention period, and a retention trigger; detect an occurrence of a retention trigger event associated with a person or a project by receiving a notification through a communication, a record update, or a manual input; query items stored within the hosted service environment to determine the item associated with an asset identifier, where the asset identifier identifies the person or the project and is included in the notification; and one of update and set the retention period and the retention type for the item based on a retention policy associated with the item, where the retention policy identifies the retention period and the retention type based on the asset identifier, the item category, and the retention trigger event.

According to yet other examples, the one or more processors may be further configured to provide extensions to an application programming interface (API) of the hosted service to enable a third party application to trigger the query in response to the third party application detecting the occurrence of the retention trigger event. The one or more processors may also be configured to prompt a creation or update of the label upon creation or modification of the item, prompt provision of the asset identifier upon the creation or update of the label, and store the label and the asset identifier as metadata of the items, where the metadata is indexed across the hosted service environment.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide event triggered data retention, the method comprising:
associating an item stored in a hosted service environment with a label, wherein the label defines one or more of an item category, a retention type, a retention period, and a retention trigger;
detecting an occurrence of a retention trigger event associated with a person or a project;
querying items stored within the hosted service environment to determine the item associated with an asset identifier, wherein the asset identifier identities the person or the project; and
one of updating and setting the retention period and the retention type for the item based on a retention policy associated with the item, wherein the retention policy identifies the retention period and the retention type based on the asset identifier, the item category, and the retention trigger event.

2. The method of claim 1, wherein the retention trigger is one of a creation date, a last modified date, a label date, and an event date.

3. The method of claim 1, wherein the retention trigger event is one of a person's resignation or termination, a project's completion or termination, a legal event, and an organizational decision.

4. The method of claim 1, wherein the retention type is one or more of keep, keep and delete, delete, move to a secure storage, lock against editing, mark as inactive or locked, and make inaccessible to a group of users.

5. The method of claim 1, wherein detecting the occurrence of the retention trigger event comprises:
receiving a notification through a communication, a record update, or a manual input.

6. The method of claim 5, wherein the notification includes the asset identifier to be used in the query.

7. The method of claim 1, further comprising:
prompting a creation or update of the label upon creation or modification of the item, wherein one or more of the item category, the retention type, the retention period, and the retention trigger defined by the label are automatically defined based on organizational defaults.

8. The method of claim 7, further comprising:
prompting provision of the asset identifier of the item upon the creation or update of the label for the item, wherein the asset identifier is stored as metadata of the item.

9. The method of claim 1, wherein the item is a document, a personal record, a communication, or non-document content.

10. The method of claim 1, wherein querying the items stored within the hosted service environment to determine the item associated with the asset identifier comprises:
querying items stored at data stores within a hosted service, items stored at storage services configured to serve the hosted service, and items stored at data stores of applications associated with the hosted service.

11. The method of claim 1, further comprising:
allowing an administrator to modify the updated or set retention type and retention period.

12. The method of claim 1, further comprising:
storing the label as metadata of item.

13. A server configured to execute a security and compliance system to provide event triggered data retention, the server comprising:
a communication interface configured to facilitate communication between another server configured to provide a hosted service environment for a tenant, one or more client devices, and the server;
a memory configured to store instructions; and
one or more processors coupled to the communication interface and the memory, the processors configured to:
associate an item stored in the hosted service environment with a label, wherein the label defines one or more of an item category, a retention type, a retention period, and a retention trigger;
detect an occurrence of a retention trigger event associated with a person or a project by receiving a notification through a communication, a record update, or a manual input;
query items stored within the hosted service environment to determine the item associated with an asset identifier, wherein the asset identifier identifies the person or the project and is included in the notification; and
one of update and set the retention period and the retention, type for the item based on a retention policy associated with the item, wherein the retention policy identifies the retention period and the retention type based on the asset identifier, the item category, and the retention trigger event.

14. The server of claim 13, wherein the one or more processors are further configured to;
roll back or pause the update or set of the retention period and the retention type for the item in response to a determination that the asset identifier was incorrect.

15. The server of claim 13, wherein the one or more processors are further configured to:
in response to a determination that the asset identifier is not associated with any item stored within the hosted service environment, provide to be displayed an error message.

16. The server of claim 13, wherein the one or more processors are further configured to:
generate, one or more reports, wherein the one or more reports include a report to determine retention trigger events present within the hosted service environment, and a report to determine items stored within the hosted service affected by a past, present, or a future retention trigger event.

17. The server of claim 13, wherein the security and compliance module is one of:
an integral module of the hosted service;
an integral module of a client application locally installed on the one or more client devices; and
a separate module associated with a protection service.

18. A system configured to provide event triggered data retention, the system comprising:
a first server configured to provide a hosted service environment for a tenant; and
a second server configured to execute a security and compliance system, the second server comprising:
a communication interface configured to facilitate communication between the first server and the second server;
a memory configured to store instructions; and
one or more processors coupled to the communication interface and the memory, the one or more processors configured to:
associate an item stored in the hosted service environment with a label, wherein the label defines one or more of an item category, a retention type, a retention period, and a retention trigger;
detect an occurrence of a retention trigger event associated with a person or a project by receiving a notification through a communication, a record update, or a manual input;
query items stored within the hosted service environment to determine the item associated with an asset identifier, wherein the asset identifier identifies the person or the project and is included in the notification; and
one of update and set the retention period and the retention type for the item based on a retention policy associated with the item, wherein the retention policy identifies the retention period and the retention type based on the asset identifier, the item category, and the retention trigger event.

19. The system of claim 18, wherein the one or more processors are further configured to:
provide extensions to an application programming interface (API) of the hosted service to enable a third party application to trigger the query in response to the third party application detecting the occurrence of the retention trigger event.

20. The system of claim 18, wherein the one or more processors are further configured to:
prompt a creation or update of the label upon creation or modification of the item,
prompt provision of the asset identifier upon the creation or update of the label, and
store the label and the asset identifier as metadata of the items, wherein the metadata is indexed across the hosted service environment.
